(19) United States
(12) Patent Application Publication
(10) Pub. No.: US 2025/0294343 A1
(43) Pub. Date: Sep. 18, 2025

(54) METHOD FOR SENDING CAPABILITY INFORMATION, METHOD FOR CAPABILITY DETERMINATION, COMMUNICATION APPARATUS, AND STORAGE MEDIUM

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/860,361

(22) PCT Filed: Apr. 25, 2022
(86) PCT No.: PCT/CN2022/089113

§ 371 Date: Oct. 25, 2024

(51) Int. Cl. H04W 8/24

(52) U.S. Cl. CPC H04W 8/24

(57) ABSTRACT

The present disclosure relates to a capability information sending method and apparatus and a capability determination method and apparatus. The capability information sending method comprises: sending capability information to a network device to indicate the capability of a terminal of supporting broadcasting of identity information of the terminal. According to the present disclosure, an unmanned aerial vehicle can send capability information to a network device, and, by means of the capability information, inform the network device of whether the unmanned aerial vehicle has the capability of identity information broadcasting, so that the network device timely determines whether the unmanned aerial vehicle supports broadcasting of the identity information itself, so as to acquire the identity information of the unmanned aerial vehicle in time. For example, for an unmanned aerial vehicle supporting identity information broadcasting, configuration information for broadcasting identity information can be sent to the unmanned aerial vehicle; and for an unmanned aerial vehicle not supporting identity information broadcasting, configuration information for identity information unicasting can be sent to the unmanned aerial vehicle, or the identity information of the unmanned aerial vehicle can be acquired in other modes.

### CROSS-REFERENCE TO RELATED APPLICATIONS

The present disclosure is a U.S. national phase of PCT Application No. PCT/CN2022/089113 filed on Apr. 25, 2022, the content of which is hereby incorporated by reference in its entirety.

### TECHNICAL FIELD

The present disclosure relates to a field of communication technologies, and in particular to a method for sending capability information, a method for capability determination, communication apparatuses, and computer-readable storage mediums.

### BACKGROUND

An unmanned-driven aerial vehicle is referred to as an unmanned aerial vehicle (UAV) for short and is an unmanned aircraft that is manipulated by a radio remote control device and a self-contained program control apparatus. The unmanned aerial vehicle is actually a general term for unmanned aircrafts, and may include from a technical perspective: an unmanned fixed-wing aircraft, an unmanned vertical take-off and landing aircraft, an unmanned airship, an unmanned helicopter, an unmanned multi-rotor aircraft, an unmanned umbrella wing aircraft, etc.

### SUMMARY

In view of this, embodiments of the present disclosure provide a method for sending capability information, a method for capability determination, communication apparatuses, and computer-readable storage mediums.

According to a first aspect of the embodiments of the present disclosure, a method for sending capability information is provided. The method is performed by a terminal and includes sending capability information to a network device, where the capability information is to indicate whether the terminal is capable of broadcasting identity information of the terminal.

According to a second aspect of the embodiments of the present disclosure, a method for capability determination is provided. The method is performed by a network device and includes: receiving capability information sent by a terminal; and determining, according to the capability information, whether the terminal is capable of broadcasting identity information of the terminal.

According to a third aspect of the embodiments of the present disclosure, a communication apparatus is provided. The communication apparatus includes: a processor; and a memory for storing a computer program, where when the computer program is executed by the processor, the method for sending capability information of any one of the above embodiments is implemented.

According to a fourth aspect of the embodiments of the present disclosure, a communication apparatus is provided. The communication apparatus includes: a processor; and a memory for storing a computer program, where when the computer program is executed by the processor, the method for capability determination of any one of the above embodiments is implemented.

According to a fifth aspect of the embodiments of the present disclosure, a computer-readable storage medium is provided. The computer-readable storage medium is configured to store a computer program; where when the computer program is executed by the processor, steps of the method for sending capability information of any one of the above embodiments are implemented.

According to a sixth aspect of the embodiments of the present disclosure, a computer-readable storage medium is provided. The computer-readable storage medium is configured to store a computer program; where when the computer program is executed by the processor, steps of the method for capability determination of any one of the above embodiments are implemented.

### BRIEF DESCRIPTION OF DRAWINGS

To more clearly describe technical solutions in embodiments of the present disclosure, accompanying drawings that need to be used in description of the embodiments will be briefly described below. Obviously, the accompanying drawings described below are for only some embodiments of the present disclosure, and those skilled in the art may also obtain other drawings based on these accompanying drawings without any creative efforts.

FIG. 1 is a schematic flowchart of a method for sending capability information shown according to an embodiment of the present disclosure.

FIG. 2 is a schematic flowchart of another method for sending capability information shown according to an embodiment of the present disclosure.

FIG. 3 is a schematic flowchart of still another method for sending capability information shown according to an embodiment of the present disclosure.

FIG. 4 is a schematic flowchart of a method for capability determination shown according to an embodiment of the present disclosure.

FIG. 5 is a schematic flowchart of another method for capability determination shown according to an embodiment of the present disclosure.

FIG. 6 is a schematic flowchart of still another method for capability determination shown according to an embodiment of the present disclosure.

FIG. 7 is a schematic block diagram of an apparatus for sending capability information shown according to an embodiment of the present disclosure.

FIG. 8 is a schematic block diagram of an apparatus for capability determination shown according to an embodiment of the present disclosure.

FIG. 9 is a schematic block diagram of an apparatus for capability determination shown according to an embodiment of the present disclosure.

FIG. 10 is a schematic block diagram of an apparatus for sending capability information shown according to an embodiment of the present disclosure.

### DETAILED DESCRIPTION

The technical solutions in the embodiments of the present disclosure will be described clearly and completely below in combination with the accompanying drawings in the embodiments of the present disclosure. Obviously, the described embodiments are merely a part of and not all of the embodiments of the present disclosure. All other embodiments obtained by those skilled in the art based on the embodiments of the present disclosure without creative efforts shall fall within the scope of protection of the present disclosure.

Terms used in the embodiments of the present disclosure are only for a purpose of describing specific embodiments, and are not intended to limit the embodiments of the present disclosure. Singular forms, “a/an” and “the” used in the embodiments and the appended claims of the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, first information may also be referred to as second information, and similarly, the second information may also be referred to as the first information. Depending on the context, the term “if” used herein may be interpreted as “when,” “while,” or “in response to determining.”

For purposes of brevity and ease of understanding, the used term is “greater than,” “less than,” “higher than,” or “lower than” when representing a size relationship herein. However, those skilled in the art may understand that the term “greater than” also covers the meaning of “greater than or equal to,” and the term “less than” also covers the meaning of “less than or equal to”; the term “higher than” covers the meaning of “higher than or equal to,” and the term “lower than” also covers the meaning of “lower than or equal to”.

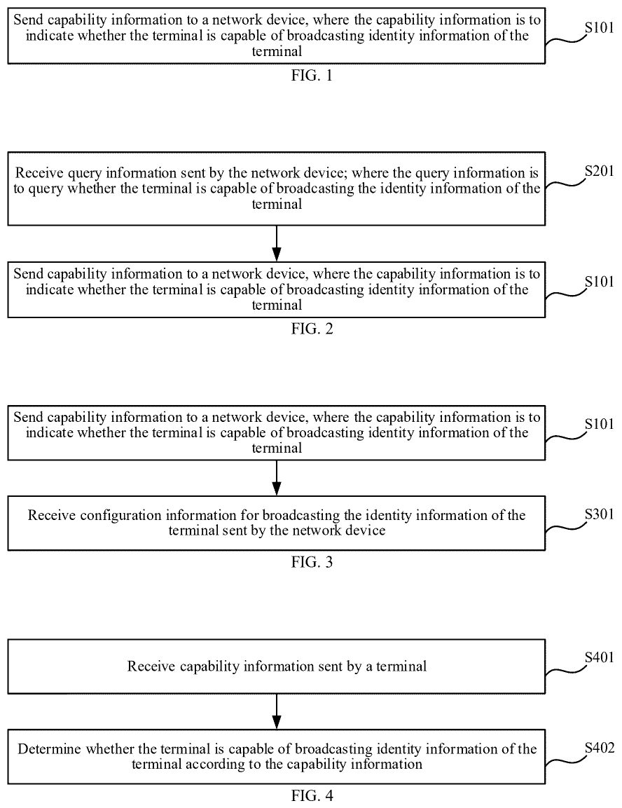

FIG. 1 is a schematic flowchart of a method for sending capability information shown according to an embodiment of the present disclosure. A terminal may perform the method for sending capability information shown in this embodiment, and the terminal includes but is not limited to a communication apparatus, such as a mobile phone, a tablet computer, a wearable device, a sensor, an Internet of Things device, etc. The terminal may communicate with a network device, including but not limited to a network device, such as a base station, a core network, etc., in a communication system, such as 4G, 5G, 6G, etc.

The following embodiments are mainly exemplary illustrated in the case where the terminal includes an unmanned aerial vehicle.

As shown in FIG. 1, the method for sending capability information may include the following step S101.

At step S101, capability information is sent to a network device, where the capability information is to indicate whether the terminal is capable of broadcasting identity information of the terminal.

In an embodiment, the unmanned aerial vehicle may send the identity information in a broadcast manner, or may send the identity information in a unicast manner, a multicast manner, etc., which may be selected specifically according to actual situations. The following content is mainly exemplary illustrated in the case where the unmanned aerial vehicle sends the identity information in the broadcast manner.

Different unmanned aerial vehicles have different capabilities. Some unmanned aerial vehicles support broadcasting their own identity information, and some unmanned aerial vehicles do not support broadcasting their own identity information. Therefore, in order to effectively control the unmanned aerial vehicle, it is necessary to obtain the identity information of the unmanned aerial vehicle in time. Therefore, it is necessary to determine whether the unmanned aerial vehicle supports broadcasting its own identity information, to obtain the identity information of the unmanned aerial vehicle in time.

According to an embodiment of the present disclosure, the unmanned aerial vehicle may send capability information to the network device, and notify the network device through the capability information whether the unmanned aerial vehicle has a capability of broadcasting the identity information, so that the network device determines in time whether the unmanned aerial vehicle supports broadcasting itself identity information, and then obtains the identity information of the unmanned aerial vehicle in time. For example, for an unmanned aerial vehicle supporting broadcasting the identity information, configuration information for broadcasting the identity information may be sent to the unmanned aerial vehicle; while for an unmanned aerial vehicle not supporting broadcasting the identity information, configuration information for unicasting the identity information may be sent to the unmanned aerial vehicle, or the identity information of the unmanned aerial vehicle may be obtained through other manners.

In an embodiment, the capability information is carried in at least one of:
user equipment evolved universal mobile telecommunications system (UMTS) terrestrial radio access network capability (UE-EUTRA-capability) information;
user equipment multi-radio technology dual-connectivity capability (UE-MRDC-capability) information; or
user equipment new radio capability (UE-NR-capability) information.

In an embodiment, the capability information is further to indicate a manner of the terminal broadcasting the identity information.

In an embodiment, the manner includes at least one of:
broadcasting through a long term evolution (LTE) air interface;
broadcasting through a new radio (NR);
broadcasting through a direct communication packet control interface 5 (PC5 interface);
broadcasting through a wireless local area network; or
broadcasting through Bluetooth.

For example, when the network device determines that the unmanned aerial vehicle supports broadcasting the identity information through the LTE air interface, the network device may configure an LTE air interface resource for the unmanned aerial vehicle to broadcast the identity information.

For example, when the network device determines that the unmanned aerial vehicle supports broadcasting the identity information through the NR, the network device may configure an NR resource for the unmanned aerial vehicle to broadcast the identity information.

For example, when the network device determines that the unmanned aerial vehicle supports broadcasting the identity information through a PC5 interface, the network device may configure a direct communication resource for the unmanned aerial vehicle to broadcast the identity information. In this case, if no PC5 interface exists between the network device and the unmanned aerial vehicle, an apparatus that has a PC5 interface with the unmanned aerial vehicle may first receive the identity information broadcast by the unmanned aerial vehicle, and then the network device obtains the identity information of the unmanned aerial vehicle from the apparatus, to obtain the identity information of the unmanned aerial vehicle in time.

For example, when the network device determines that the unmanned aerial vehicle supports broadcasting the identity information through a wireless local area network, an apparatus located in the same wireless local area network as the unmanned aerial vehicle may first receive the identity information broadcast by the unmanned aerial vehicle, and then the network device obtains the identity information of the unmanned aerial vehicle from the apparatus, to obtain the identity information of the unmanned aerial vehicle in time.

For example, when the network device determines that the unmanned aerial vehicle supports broadcasting the identity information through the Bluetooth, an apparatus that can communicate with the unmanned aerial vehicle through the Bluetooth may first receive the identity information broadcast by the unmanned aerial vehicle, and then the network device obtains the identity information of the unmanned aerial vehicle from the apparatus, to obtain the identity information of the unmanned aerial vehicle in time.

FIG. 2 is a schematic flowchart of another method for sending capability information shown according to an embodiment of the present disclosure. As shown in FIG. 2, the method further includes step S201.

At step S201, query information (or UE capability enquiry) sent by the network device is received; where the query information is to query whether the terminal is capable of broadcasting the identity information of the terminal.

In an embodiment, when the network device is to determine whether the terminal supports broadcasting the identity information, the network device may first send the query information to the terminal, where the query information may include RRC (radio resource control) signaling, for example, UE capability enquiry signaling. After the terminal receives the query information, the terminal only sends the capability information to the network device.

Of course, it may also be provided that the terminal can send the capability information to the network device as required in the case where the terminal does not receive the query information.

In an embodiment, the query information is to query whether the terminal is capable of broadcasting the identity information of the terminal in a specific manner.

The network device may further query, with the query information, whether the terminal is capable of specifically broadcasting the identity information of the terminal in the specific manner, and when the network device sends the capability information, the terminal may further indicate, with the capability information, a supported manner of broadcasting the identity information.

When querying whether the terminal is capable of broadcasting the identity information of the terminal through a plurality of specific manners, priorities may be configured for the plurality of specific manners. The terminal may determine, according to the priorities, whether the terminal supports the plurality of specific manners. When the terminal determines whether the terminal supports a manner with a relatively high priority, the terminal does not need to determine whether the terminal supports a manner with a relatively low priority, to save terminal resources.

For example, the network device may query, with the query information, whether the terminal supports broadcasting through the LTE air interface, broadcasting through the NR, and broadcasting through the PC5 interface, and the three manners with from high to low priorities are broadcasting through the NR, broadcasting through the LTE air interface, and broadcasting through the PC5 interface. The terminal may first determine, according to the query information, whether the terminal supports broadcasting through the NR, and if the terminal determines that the terminal supports broadcasting through the NR, the terminal does not need to determine whether the terminal supports broadcasting through the LTE air interface and broadcasting through the PC5 interface, and the terminal indicates, with the capability information, that the terminal supports broadcasting through the NR.

FIG. 3 is a schematic flowchart of still another method for sending capability information shown according to an embodiment of the present disclosure. As shown in FIG. 3, the method further includes step S301.

At step S301, configuration information sent by the network device is received; where the configuration information is to configure the terminal to broadcast the identity information of the terminal.

In an embodiment, in the case where the network device determines, according to the capability information, that the terminal supports broadcasting the identity information, the network device may send the configuration information for the broadcasting the identity information to the terminal, and the terminal may broadcast the identity information according to the configuration information.

In an embodiment, the configuration information includes at least one of:
a manner of broadcasting the identity information; where the unmanned aerial vehicle may broadcast the identity information according to the manner;
a time condition for broadcasting the identity information, such as a start time and an end time; where the unmanned aerial vehicle may start broadcasting the identity information at the start time and end broadcasting the identity information at the end time;
a height condition for broadcasting the identity information; where the unmanned aerial vehicle may only start broadcasting the identity information when a height of the unmanned aerial vehicle meets the height condition; or
an association relationship between the capability of broadcasting the identity information of the terminal and whether allowing a specific action to be performed; where the specific action includes but is not limited to takeoff, landing, etc.; for example, not supporting broadcasting the identity information is associated with allowing takeoff, and the unmanned aerial vehicle may not take off according to the configuration information in the case where the unmanned aerial vehicle does not support broadcasting the identity information, to avoid that the network device is difficult to obtain the identity information of the unmanned aerial vehicle and cannot effectively control the unmanned aerial vehicle.

It should be noted that the above configuration information is merely an example, and content in the configuration information may be actually configured as required. For example, the configuration information may further include an end condition for broadcasting the identity information, for example, the end condition is landing of the unmanned aerial vehicle.

In an embodiment, the configuration information is carried in at least one of:
RRC reconfiguration signaling; for example, the network device is a network device in an NR system, the RRC reconfiguration signaling may carry the configuration information, and the network device may send the RRC reconfiguration signaling to the terminal, for example, the configuration information is carried in other configuration (other Config) signaling in the RRC reconfiguration signaling; or
RRC connection reconfiguration signaling; for example, the network device is a network device in an LTE system, the RRC connection reconfiguration signaling may carry the configuration information, and the network device may send the RRC connection reconfiguration signaling to the terminal, for example, the configuration information is carried in other configuration signaling in the RRC connection reconfiguration signaling.

FIG. 4 is a schematic flowchart of a method for capability determination shown according to an embodiment of the present disclosure. The method for capability determination in this embodiment may be performed by a network device. The network device may communicate with a terminal. The network device includes but is not limited to a base station, such as a 4G base station, a 5G base station, a 6G base station, etc., in a communication system. The terminal includes but is not limited to a communication apparatus, such as an unmanned aerial vehicle, a mobile phone, a tablet computer, a wearable device, a sensor, an Internet of Things device, etc.

The following embodiments are mainly exemplary illustrated in the case where the terminal includes an unmanned aerial vehicle.

As shown in FIG. 4, the method for capability determination may include the following steps S401-S402.

At step S401, capability information sent by a terminal is received.

At step S402, whether the terminal is capable of broadcasting identity information of the terminal is determined according to the capability information.

In an embodiment, the unmanned aerial vehicle may send the identity information in a broadcast manner, or may send the identity information in a unicast manner, a multicast manner, etc., which may be selected specifically according to actual situations. The following content is mainly exemplary illustrated in the case where the unmanned aerial vehicle sends the identity information in the broadcast manner.

Different unmanned aerial vehicles have different capabilities. Some unmanned aerial vehicles support broadcasting their own identity information, and some unmanned aerial vehicles do not support broadcasting their own identity information. Therefore, in order to effectively control the unmanned aerial vehicle, it is necessary to obtain the identity information of the unmanned aerial vehicle in time. Therefore, it is necessary to determine whether the unmanned aerial vehicle supports broadcasting its own identity information, to obtain the identity information of the unmanned aerial vehicle in time.

According to an embodiment of the present disclosure, the unmanned aerial vehicle may send capability information to the network device, and notify the network device through the capability information whether the unmanned aerial vehicle has a capability of broadcasting the identity information, so that the network device determines in time whether the unmanned aerial vehicle supports broadcasting itself identity information, and then obtains the identity information of the unmanned aerial vehicle in time. For example, for an unmanned aerial vehicle supporting broadcasting the identity information, configuration information for broadcasting the identity information may be sent to the unmanned aerial vehicle; while for an unmanned aerial vehicle not supporting broadcasting the identity information, configuration information for unicasting the identity information may be sent to the unmanned aerial vehicle, or the identity information of the unmanned aerial vehicle may be obtained through other manners.

In an embodiment, the capability information is carried in at least one of:
UE-EUTRA-capability information;
UE-MRDC-capability information; or
UE-NR-capability information.

In an embodiment, the capability information is further to indicate a manner of the terminal broadcasting the identity information.

In an embodiment, the manner includes at least one of:
broadcasting through an LTE air interface;
broadcasting through an NR;
broadcasting through a direct communication PC5 interface;
broadcasting through a wireless local area network; or
broadcasting through Bluetooth.

For example, when the network device determines that the unmanned aerial vehicle supports broadcasting the identity information through the LTE air interface, the network device may configure an LTE air interface resource for the unmanned aerial vehicle to broadcast the identity information.

For example, when the network device determines that the unmanned aerial vehicle supports broadcasting the identity information through the NR, the network device may configure an NR resource for the unmanned aerial vehicle to broadcast the identity information.

For example, when the network device determines that the unmanned aerial vehicle supports broadcasting the identity information through a PC5 interface, the network device may configure a direct communication resource for the unmanned aerial vehicle to broadcast the identity information. In this case, if no PC5 interface exists between the network device and the unmanned aerial vehicle, an apparatus that has a PC5 interface with the unmanned aerial vehicle may first receive the identity information broadcast by the unmanned aerial vehicle, and then the network device obtains the identity information of the unmanned aerial vehicle from the apparatus, to obtain the identity information of the unmanned aerial vehicle in time.

For example, when the network device determines that the unmanned aerial vehicle supports broadcasting the identity information through a wireless local area network, an apparatus located in the same wireless local area network as the unmanned aerial vehicle may first receive the identity information broadcast by the unmanned aerial vehicle, and then the network device obtains the identity information of the unmanned aerial vehicle from the apparatus, to obtain the identity information of the unmanned aerial vehicle in time.

For example, when the network device determines that the unmanned aerial vehicle supports broadcasting the identity information through the Bluetooth, an apparatus that can communicate with the unmanned aerial vehicle through the Bluetooth may first receive the identity information broadcast by the unmanned aerial vehicle, and then the network device obtains the identity information of the unmanned aerial vehicle from the apparatus, to obtain the identity information of the unmanned aerial vehicle in time.

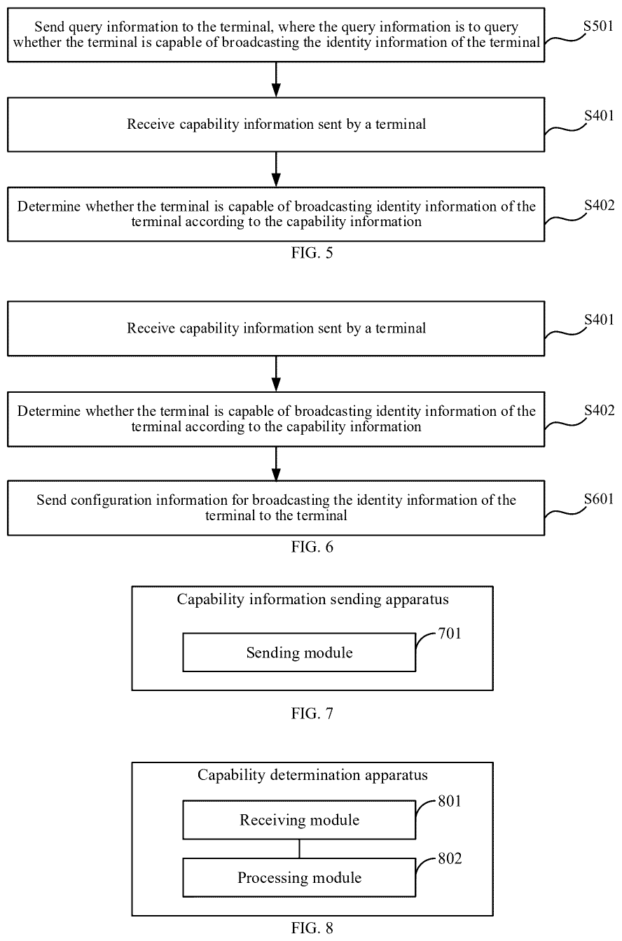

FIG. 5 is a schematic flowchart of another method for capability determination shown according to an embodiment of the present disclosure. As shown in FIG. 5, the method further includes step S501.

At step S501, query information is sent to the terminal, where the query information is to query whether the terminal is capable of broadcasting the identity information of the terminal.

In an embodiment, when the network device is to determine whether the terminal supports broadcasting the identity information, the network device may first send the query information to the terminal, where the query information may include RRC signaling, for example, UE capability enquiry signaling. After the terminal receives the query information, the terminal only sends the capability information to the network device.

Of course, it may also be provided that the terminal can send the capability information to the network device as required in the case where the terminal does not receive the query information.

In an embodiment, the query information is to query whether the terminal is capable of broadcasting the identity information of the terminal in a specific manner.

The network device may further query, with the query information, the capability of the terminal specifically broadcasting the identity information of the terminal in the specific manner, and when the network device sends the capability information, the terminal may further indicate, with the capability information, a supported manner of broadcasting the identity information.

When querying the capability of the terminal broadcasting the identity information of the terminal through a plurality of specific manners, priorities may be configured for the plurality of specific manners. The terminal may determine, according to the priorities, whether the terminal supports the plurality of specific manners. When the terminal determines whether the terminal supports a manner with a relatively high priority, the terminal does not need to determine whether the terminal supports a manner with a relatively low priority, to save terminal resources.

For example, the network device may query, with the query information, whether the terminal supports broadcasting through the LTE air interface, broadcasting through the NR, and broadcasting through the PC5 interface, and the three manners with from high to low priorities are broadcasting through the NR, broadcasting through the LTE air interface, and broadcasting through the PC5 interface. The terminal may first determine, according to the query information, whether the terminal supports broadcasting through the NR, and if the terminal determines that the terminal supports broadcasting through the NR, the terminal does not need to determine whether the terminal supports broadcasting through the LTE air interface and broadcasting through the PC5 interface, and the terminal indicates, with the capability information, that the terminal supports broadcasting through the NR.

FIG. 6 is a schematic flowchart of still another method for capability determination shown according to an embodiment of the present disclosure. As shown in FIG. 6, the method further includes step S601.

At step S601, configuration information for broadcasting the identity information of the terminal is sent to the terminal.

In an embodiment, in the case where the network device determines, according to the capability information, that the terminal supports broadcasting the identity information, the network device may send the configuration information for the broadcasting the identity information to the terminal, and the terminal may broadcast the identity information according to the configuration information.

In an embodiment, the configuration information includes at least one of:
a manner of broadcasting the identity information;
a time condition for broadcasting the identity information;
a height condition for broadcasting the identity information; or
an association relationship between the capability of broadcasting the identity information of the terminal and whether allowing a specific action to be performed.

There is an association relationship between the capability of broadcasting the identity information of the terminal and whether allowing a specific action to be performed; where the specific action includes but is not limited to takeoff, landing, etc.; for example, not supporting broadcasting the identity information is associated with allowing takeoff, and the unmanned aerial vehicle may not take off according to the configuration information in the case where the unmanned aerial vehicle does not support broadcasting the identity information, to avoid that the network device is difficult to obtain the identity information of the unmanned aerial vehicle and cannot effectively control the unmanned aerial vehicle.

It should be noted that the above configuration information is merely an example, and content in the configuration information may be actually configured as required. For example, the configuration information may further include an end condition for broadcasting the identity information, for example, the end condition is landing of the unmanned aerial vehicle.

In an embodiment, the configuration information is carried in at least one of:
RRC reconfiguration signaling; for example, the network device is a network device in an NR system, the RRC reconfiguration signaling may carry the configuration information, and the network device may send the RRC reconfiguration signaling to the terminal; or
RRC connection reconfiguration signaling; for example, the network device is a network device in an LTE system, the RRC connection reconfiguration signaling may carry the configuration information, and the network device may send the RRC connection reconfiguration signaling to the terminal.

Corresponding to the above embodiments of the method for sending capability information and the method for capability determination, the present disclosure further provides embodiments of an apparatus for sending capability information and an apparatus for capability determination.

FIG. 7 is a schematic block diagram of an apparatus for sending capability information shown according to an embodiment of the present disclosure. The apparatus for sending capability information shown in this embodiment may be applied to a terminal, and the terminal includes but is not limited to a communication apparatus, such as a mobile phone, a tablet computer, a wearable device, a sensor, an Internet of Things device, etc. The terminal may communicate with a network device, and the network device includes but is not limited to a network device, such as a base station, a core network, etc., in a communication system, such as 4G, 5G, 6G, etc.

The following embodiments are mainly exemplary illustrated in the case where the terminal includes an unmanned aerial vehicle.

As shown in FIG. 7, the apparatus for sending capability information may include:
a sending module 701, configured to send capability information to a network device, where the capability information is to indicate whether the terminal is capable of broadcasting identity information of the terminal.

In an embodiment, the capability information is carried in at least one of: UE-EUTRA-capability information; UE-MRDC-capability information; or UE-NR-capability information.

In an embodiment, the capability information is further to indicate a manner of the terminal broadcasting the identity information.

In an embodiment, the manner includes at least one of: broadcasting through an LTE air interface; broadcasting through an NR; broadcasting through a direct communication PC5 interface; broadcasting through a wireless local area network; or broadcasting through Bluetooth.

In an embodiment, the apparatus further includes: a receiving module, configured to receive query information sent by the network device, where the query information is to query whether the terminal is capable of broadcasting the identity information of the terminal.

In an embodiment, the query information is to query whether the terminal is capable of broadcasting the identity information of the terminal in a specific manner.

In an embodiment, the apparatus further includes: a receiving module, configured to receive configuration information sent by the network device; where the configuration information is to configure the terminal to broadcast the identity information of the terminal.

In an embodiment, the configuration information includes at least one of: a manner of broadcasting the identity information; a time condition for broadcasting the identity information; a height condition for broadcasting the identity information; or an association relationship between the capability of broadcasting the identity information of the terminal and whether allowing a specific action to be performed.

In an embodiment, the configuration information is carried in at least one of: RRC reconfiguration signaling or RRC connection reconfiguration signaling.

FIG. 8 is a schematic block diagram of an apparatus for capability determination shown according to an embodiment of the present disclosure. The apparatus for capability determination in this embodiment may be applied to a network device. The network device may communicate with a terminal. The network device includes but is not limited to a base station, such as a 4G base station, a 5G base station, a 6G base station, etc., in a communication system. The terminal includes but is not limited to a communication apparatus, such as an unmanned aerial vehicle, a mobile phone, a tablet computer, a wearable device, a sensor, an Internet of Things device, etc.

The following embodiments are mainly exemplary illustrated in the case where the terminal includes an unmanned aerial vehicle.

As shown in FIG. 8, the apparatus for capability determination may include:
a receiving module 801, configured to receive capability information sent by a terminal; and
a processing module 802, configured to determine, according to the capability information, whether the terminal is capable of broadcasting identity information of the terminal.

In an embodiment, the capability information is carried in at least one of: UE-EUTRA-capability information; UE-MRDC-capability information; or UE-NR-capability information.

In an embodiment, the capability information is further to indicate a manner of the terminal broadcasting the identity information.

In an embodiment, the manner includes at least one of: broadcasting through an LTE air interface; broadcasting through an NR; broadcasting through a direct communication PC5 interface; broadcasting through a wireless local area network; or broadcasting through Bluetooth.

In an embodiment, the apparatus further includes: a sending module, configured to send query information to the terminal; where the query information is to query whether the terminal is capable of broadcasting the identity information of the terminal.

In an embodiment, the query information is to query whether the terminal is capable of broadcasting the identity information of the terminal in a specific manner.

In an embodiment, the apparatus further includes: a sending module, configured to send configuration information for broadcasting the identity information of the terminal to the terminal.

In an embodiment, the configuration information includes at least one of: a manner of broadcasting the identity information; a time condition for broadcasting the identity information; a height condition for broadcasting the identity information; or an association relationship between the capability of broadcasting the identity information of the terminal and whether allowing a specific action to be performed.

In an embodiment, the configuration information is carried in at least one of: RRC reconfiguration signaling or RRC connection reconfiguration signaling.

The specific manners in which each of the modules of the apparatus in the above embodiments performs operations have been described in detail in the embodiments related to the method, and will not be explained here in detail.

Since the embodiments of the apparatuses substantially corresponds to the embodiments of the methods, and the related contents may refer to the description of the embodiments of the methods. The embodiments of the apparatus described above are only schematic. The modules explained as separate components may be or may not be physically separated, and the components displayed as modules may be or may not be physical modules, that is, they may be located in one place or may be distributed across multiple network modules. A part or all of modules may be selected according to actual needs to achieve the purpose of the solutions in these embodiments. Those skilled in the art may understand and implement other embodiments without a creative work.

An embodiment of the present disclosure further provides a communication apparatus, including: a processor; and a memory for storing a computer program, where when the computer program is executed by the processor, the method for sending capability information of any one of the above embodiments is implemented.

An embodiment of the present disclosure further provides a communication apparatus, including: a processor; and a memory for storing a computer program, where when the computer program is executed by the processor, the method for capability determination of any one of the above embodiments is implemented.

An embodiment of the present disclosure further provides a computer-readable storage medium, configured to store a computer program; where when the computer program is executed by the processor, steps of the method for sending capability information of any one of the above embodiments are implemented.

An embodiment of the present disclosure further provides a computer-readable storage medium, configured to store a computer program; where when the computer program is executed by the processor, steps of the method for capability determination of any one of the above embodiments are implemented.

As shown in FIG. 9, FIG. 9 is a schematic block diagram of an apparatus for capability determination 900 shown according to an embodiment of the present disclosure. The apparatus 900 may be provided as a base station. Referring to FIG. 9, the apparatus 900 includes a processing component 922, a wireless transmit/receive component 924, an antenna component 926, and a signal processing part specific to a wireless interface. The processing component 922 may further include one or more processors. One processor of the processing component 922 may be configured to implement the method for capability determination of any one of the above embodiments.

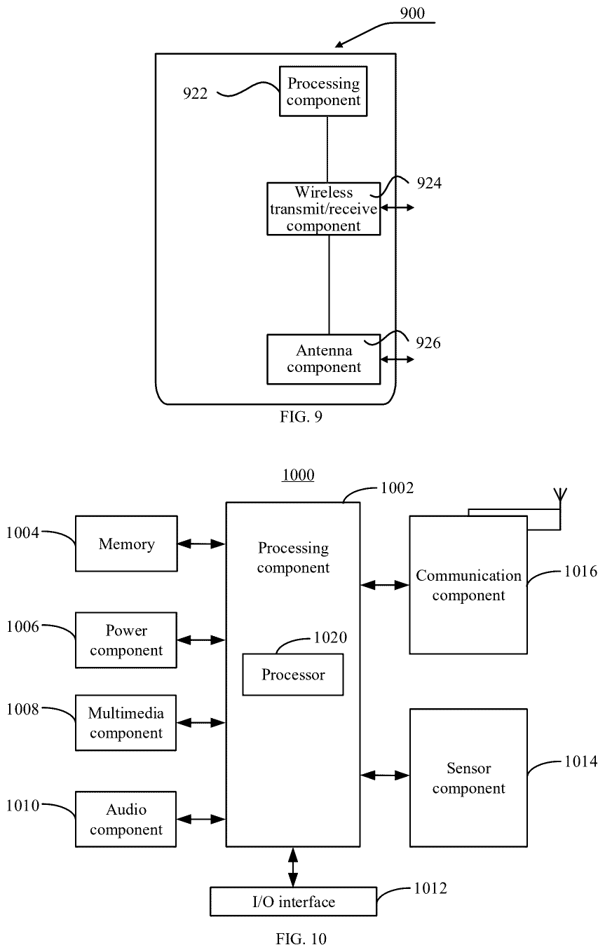

FIG. 10 is a schematic block diagram of an apparatus for sending capability information 100 shown according to an embodiment of the present disclosure. For example, the apparatus 1000 may be a mobile phone, a computer, a digital broadcast terminal, a message transceiving device, a game console, a tablet device, a medical device, a fitness device, a personal digital assistant, etc.

Referring to FIG. 10, the apparatus 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls the overall operation of the apparatus 1000, such as operations associated with display, phone calls, data communication, camera operations, and recording operations. The processing component 1002 may include one or more processors 1020 to perform instructions to complete all or part of the steps of the above method for sending capability information. Additionally, the processing component 1002 may include one or more modules to facilitate interaction between the processing component 1002 and other components. For example, the processing component 1002 may include a multimedia module to facilitate interaction between the multimedia component 1008 and the processing component 1002.

The memory 1004 is configured to store various types of data to support operations of the apparatus 1000. Examples of such data include instructions, contact data, phonebook data, messages, pictures, videos, etc., for any application program or method operating on the apparatus 1000. The memory 1004 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 1006 provides power to various components of the apparatus 1000. The power component 1006 may include a power supply management system, one or more power supplies, and other components that are associated with generating, managing, and distributing power for the apparatus 1000.

The multimedia component 1008 includes a screen providing an output interface between the apparatus 1000 and the user. In some embodiments, the screen may include a liquid crystal display (LCD) and a touch panel (TP). If the screen includes the touch panel, the screen may be implemented as a touch screen, to receive an input signal from the user. The touch panel includes one or more touch sensors to sense the touch, the slide, and the gesture on the touch panel. The touch sensor may not only sense a boundary of the touch or slide action, but also detect a duration and pressure related to the touch or slide operation. In some embodiments, the multimedia component 1008 includes a front facing camera and/or a rear facing camera. When the apparatus 1000 is in an operation mode, such as a shooting mode or a video mode, the front facing camera and/or the rear facing camera may receive external multimedia data. Each of the front facing camera and rear facing camera may be a fixed optical lens system or has a focal length and an optical zoom capability.

The audio component 1010 is configured to output and/or input audio signals. For example, the audio component 1010 includes a microphone (MIC). The microphone is configured to receive external audio signals when the apparatus 1000 is in the operating mode, such as a call mode, a recording mode, and a speech recognition mode. The received audio signals may be further stored in the memory 1004 or sent via the communication component 1016. In some embodiments, the audio component 1010 also includes a speaker to output the audio signals.

The I/O interface 1012 provides an interface between the processing component 1002 and peripheral interface modules. The peripheral interface modules may be keyboards, click wheels, buttons, etc. These buttons may include but are not limited to: a home button, a volume button, a start button, and a lock button.

The sensor component 1014 includes one or more sensors to provide various aspects of state assessment for the apparatus 1000. For example, the sensor component 1014 may detect an open/closed state of the apparatus 1000, relative positioning of components that are for example a display and keypad of the apparatus 1000. The sensor component 1014 may also detect a position change of the apparatus 1000 or of a component of the apparatus 1000, presence or absence of the user contacting with the apparatus 1000, an orientation or acceleration/deceleration of the apparatus 1000, and a temperature change of the apparatus 1000. The sensor component 1014 may include a proximity sensor configured to detect the presence of nearby objects without any physical contact. The sensor component 1014 may also include a light sensor, such as a CMOS or CCD image sensor, for use in an imaging application. In some embodiments, the sensor component 1014 may also include an acceleration sensor, a gyroscope sensor, a magnetic sensor, a pressure sensor, or a temperature sensor.

The communication component 1016 is configured to facilitate wired or wireless communication between the apparatus 1000 and other devices. The apparatus 1000 may access a wireless network based on a communication standard, such as WiFi, 2G, 3G, 4G LTE, 5G NR, or a combination of them. In an exemplary embodiment, the communication component 1016 receives, via a broadcast channel, a broadcast signal or broadcast related information from an external broadcast management system. In an exemplary embodiment, the communication component 1016 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the apparatus 1000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above method for sending capability information.

In an exemplary embodiment, a non-transitory computer-readable storage medium including instructions is also provided, such as the memory 1004 including the instructions. The above instructions may be performed by the processor 1020 of the apparatus 1000 to complete the above method for sending capability information. For example, the non-transitory computer-readable storage medium may be a ROM, a random access memory (RAM), a CD-ROM, a magnetic tape, a floppy disk, an optical data storage device, etc.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes may be made without departing from its scope. The scope of the present disclosure is limited only by the appended claims.

It should be noted that the relationship terms used herein, such as “first,” “second” and the like are only to distinguish one entity or operation from another entity or operation, but do not necessarily require or imply that there is any actual relationship or order between these entities or operations. The terms “include,” “comprise,” or any variants thereof are intended to cover a non-exclusive inclusion, such that processes, methods, articles, or devices, including a series of elements, include not only those elements that have been listed, but also other elements that are not specifically listed or the elements intrinsic to these processes, methods, articles, or devices. Without further limitations, elements limited by the wording “include(s) a/an . . . ” or “comprise(s) a/an . . . ” do not exclude additional identical elements in the processes, methods, articles or devices, including the listed elements.

The method and apparatus provided by the embodiments of the present disclosure are described in detail above, specific examples are applied herein to describe the principles and implementations of the present disclosure, and the description of the above embodiments is only used to help understand the method of the present disclosure and the core idea thereof; meanwhile, for those skilled in the art, according to the idea of the present disclosure, there will be changes in the specific implementations and application scope. In summary, the content of the present disclosure should not be construed as limiting the present disclosure.

According to a seventh aspect of the embodiments of the present disclosure, an apparatus for sending capability information is provided. The apparatus is applied to a terminal and includes: a sending module, configured to send capability information to a network device, where the capability information is to indicate whether the terminal is capable of broadcasting identity information of the terminal.

According to an eighth aspect of the embodiments of the present disclosure, an apparatus for capability determination is provided. The apparatus is applied to a network device and includes: a receiving module, configured to receive capability information sent by a terminal; and a processing module, configured to determine, according to the capability information, whether the terminal is capable of broadcasting identity information of the terminal.

1. A method for sending capability information performed by a terminal, the method comprising:
sending the capability information to a network device, wherein the capability information is to indicate whether the terminal is capable of broadcasting identity information of the terminal.

2. The method of claim 1, wherein the capability information is carried in at least one of:
user equipment evolved universal mobile telecommunications system (UMTS) terrestrial radio access network capability (UE-EUTRA-capability) information;
user equipment multi-radio technology dual-connectivity capability (UE-MRDC-capability) information; or
user equipment new radio capability (UE-NR-capability) information.

3. The method of claim 1, wherein the capability information is further to indicate a manner of the terminal broadcasting identity information.

4. The method of claim 3, wherein the manner comprises at least one of:
broadcasting through a long term evolution (LTE) air interface;
broadcasting through a new radio (NR);
broadcasting through a direct communication packet control interface 5 (PC5 interface);
broadcasting through a wireless local area network; or
broadcasting through Bluetooth.

5. The method of claim 1, further comprising:
receiving query information sent by the network device, wherein the query information is to query whether the terminal is capable of broadcasting identity information of the terminal; wherein the query information is to query whether the terminal is capable of broadcasting identity information of the terminal in a specific manner.

6. (canceled)

7. The method of claim 1, further comprising:
receiving configuration information sent by the network device, wherein the configuration information is to configure the terminal to broadcast the identity information of the terminal.

8. The method of claim 7, wherein the configuration information comprises at least one of:
a manner of broadcasting the identity information;
a time condition for broadcasting the identity information;
a height condition for broadcasting the identity information; or
an association relationship between the capability of broadcasting the identity information of the terminal and whether allowing a specific action to be performed.

9. The method of claim 7, wherein the configuration information is carried in at least one of:
radio resource control (RRC) reconfiguration signaling; or
RRC connection reconfiguration signaling.

10. A method for capability determination performed by a network device, the method comprising:
receiving capability information sent by a terminal; and
determining, according to the capability information, whether the terminal is capable of broadcasting identity information of the terminal.

11. The method of claim 10, wherein the capability information is carried in at least one of:
user equipment evolved universal mobile telecommunications system (UMTS) terrestrial radio access network capability (UE-EUTRA-capability) information;
user equipment multi-radio technology dual-connectivity capability (UE-MRDC-capability) information; or
user equipment new radio capability (UE-NR-capability) information.

12. The method of claim 10, wherein the capability information is further to indicate a manner of the terminal broadcasting the identity information.

13. The method of claim 12, wherein the manner comprises at least one of:
broadcasting through a long term evolution (LTE) air interface;
broadcasting through a new radio (NR);
broadcasting through a direct communication packet control interface 5 (PC5 interface);
broadcasting through a wireless local area network; or
broadcasting through Bluetooth.

14. The method of claim 10, further comprising:
sending query information to the terminal, wherein the query information is to query whether the terminal is capable of broadcasting the identity information of the terminal; wherein the query information is to query whether the terminal is capable of broadcasting the identity information of the terminal in a specific manner.

15. (canceled)

16. The method of claim 10, further comprising:
sending configuration information for broadcasting the identity information of the terminal to the terminal.

17. The method of claim 16, wherein the configuration information comprises at least one of:
a manner of broadcasting the identity information;
a time condition for broadcasting the identity information;
a height condition for broadcasting the identity information; or
an association relationship between the capability of broadcasting the identity information of the terminal and whether allowing a specific action to be performed.

18. The method of claim 16, wherein the configuration information is carried in at least one of:
radio resource control (RRC) reconfiguration signaling; or
RRC connection reconfiguration signaling.

19. (canceled)

20. (canceled)

21. A communication apparatus, comprising:
a processor; and
a memory for storing a computer program;
wherein the computer program, when executed by the processor, causes the communication apparatus to:
send capability information to a network device, wherein the capability information is to indicate whether a terminal is capable of broadcasting identity information of the terminal.

22. A communication apparatus, comprising:
a processor; and
a memory for storing a computer program;
wherein the computer program, when executed by the processor, causes the communication apparatus to act as the network device and perform the method of claim 10.

23. A non-transitory computer-readable storage medium, for storing a computer program; wherein the computer program, when executed by a processor of the terminal, causes the terminal to perform the method of claim 1.

24. A non-transitory computer-readable storage medium, for storing a computer program; wherein the computer program, when executed by a processor of the terminal, causes the terminal to perform the method of claim 10.
